(19) United States
(12) Patent Application Publication
(10) Pub. No.: US 2014/0319705 A1
(43) Pub. Date: Oct. 30, 2014

(54) VAPOR CONCENTRATION CONTROL SYSTEM, VAPOR CONCENTRATION CONTROL DEVICE AND CONTROL PROGRAM

(71) Applicant: HORIBA STEC, Co., Ltd., Kyoto-shi (JP)

(72) Inventor: Tatsuya Hayashi, Kyoto-shi (JP)

(73) Assignee: HORIBA STEC, Co., Ltd., Kyoto-shi (JP)

(21) Appl. No.: 14/261,359

(22) Filed: Apr. 24, 2014

(30) Foreign Application Priority Data
Apr. 25, 2013 (JP) 2013-091932
Feb. 28, 2014 (JP) 2014-037922

(51) Int. Cl. B01F 3/04

(52) U.S. Cl. CPC B01F 3/0446
USPC 261/43; 261/64.1

(57) ABSTRACT

The present claimed invention includes a first flow channel where a carrier gas or a mixed gas flows, a switch valve that is for flowing the mixed gas or the carrier gas to the first flow channel selectively, a fluid adjusting valve that adjusts a concentration of a gas flowing in the first flow channel, and a control part that conducts a feedback control on an opening degree of the fluid adjusting valve, and is characterized such that the control part initiates the feedback control by the use of an opening degree of the fluid adjusting valve at a time just before the gas flowing in the first flow channel is switched from the mixed gas to the carrier gas as an initial opening degree of the fluid adjusting valve at a time when the gas flowing in the first flow channel is again switched to the mixed gas afterward.

### FIELD OF THE ART

This invention relates to a vapor concentration control system, a vapor concentration control device, and a control program.

### BACKGROUND ART

One method for vaporizing a material is a bubbling method that vaporizes a liquid material stored in a tank by the use of a carrier gas. For example, a device described in Patent Document 1 is represented as a vapor concentration control device using this bubbling method.

The device described in the patent document 1 comprises a tank to house a material, an introducing pipe to introduce a carrier gas into the tank, a lead out pipe to lead out a mixed gas made of the material gas, which is vaporized material, and the carrier gas from the tank, a body where an internal flow channel that is connected to the lead out pipe is provided, a concentration measuring part to measure a concentration of the material gas that flows in the internal flow channel and a first valve that adjusts a measurement concentration measured by the concentration measuring part in the downstream of the concentration measuring part to a previously determined set concentration.

### PRIOR ART DOCUMENT

### Patent Document

Patent Document 1: Japanese Unexamined Patent Application Publication No. 2010-109303

### DISCLOSURE OF THE INVENTION

### Problems to be Solved by the Invention

In the case that the vapor concentration control device described in the patent document 1 produces the carrier gas or the mixed gas selectively and the produced gas is the carrier gas, since no material gas is contained in the carrier gas, the concentration measured by the concentration measuring part becomes zero.

Then, the opening degree of the first valve increases in order to raise the measurement concentration to the set concentration. However, since the measurement concentration remains zero while the carrier gas is produced, the opening degree of the first valve gradually increases and is finally in a fully open state.

If the gas produced in this state is switched from the carrier gas to the mixed gas, the concentration of the material gas rapidly rises and the measurement concentration becomes quite different from the set concentration. Then, there is a problem of generating overshoot because it is not possible to suppress the rise of the measurement concentration while the opening degree of the first valve is adjusted in order to make the measurement concentration approach the set concentration.

As a method for preventing the overshoot represented is a method that prevents overshoot at a time when the gas is switched from the carrier gas to the mixed gas, wherein a line to flow the carrier gas and a line to flow the mixed gas are provided separately, and the measurement concentration of the material gas contained in the mixed gas is adjusted to approach the set concentration on a constant basis by also producing and discharging the mixed gas while the carrier gas is produced.

However, with this method, since the line for flowing the carrier gas and the line for flowing the mixed gas are separately arranged, a number of components increases and more gas and material are consumed than is necessary, resulting in a new problem where a running cost is increased.

In view of the above-mentioned problem, for a vapor concentration control device that produces either one of the carrier gas and the mixed gas selectively, an object of the present claimed invention is to provide a vapor concentration control device that can prevent overshoot wherein the measurement concentration of the material gas contained in the mixed gas becomes equal to or more than the previously determined set concentration, without increasing the cost.

### Means to Solve the Problems

The vapor concentration control system of this invention comprises a storage tank that stores a liquid or solid material, where a carrier gas is introduced and a mixed gas is led out, the mixed gas being made of the carrier gas and material gas which is vaporized material from the liquid or solid material, a first flow channel that is arranged on a downstream side of the storage tank, a switch valve that is for flowing the mixed gas or the carrier gas to the first flow channel selectively, a fluid adjusting valve that adjusts a concentration of a gas flowing in the first flow channel, a concentration sensor that measures a concentration of the material gas in the gas flowing in the first flow channel, and a control part that conducts a feedback control on an opening degree of the fluid adjusting valve so as to make a measurement concentration measured by the concentration sensor or its related value approach a previously determined set concentration or its related value when the mixed gas flows in the first flow channel, and is characterized by that the control part initiates the feedback control by the use of the opening degree of the fluid adjusting valve at a time just before the gas flowing in the first flow channel is switched from the mixed gas to the carrier gas as an initial opening degree of the fluid adjusting valve at a time when the gas flowing in the first flow channel is again switched to the mixed gas afterward.

With this arrangement, since the control part initiates the feedback control by the use of the opening degree of the fluid adjusting valve at the time just before the gas flowing in the first flow channel is switched from the mixed gas to the carrier gas as the initial opening degree, even though the opening degree of the fluid adjusting valve increases because of the carrier gas flowing in the first flow channel, the measurement concentration at the opening degree of the fluid adjusting valve at the time just before the gas flowing in the first flow channel is switched from the mixed gas to the carrier gas becomes an approximate value to the set concentration unless the set concentration of the feedback control part at a previous time largely differs from the set concentration of the feedback control part at this time. As a result of this, it is possible to prevent overshoot due to the feedback control of the fluid adjusting valve failing to be effective in time.

In addition, in accordance with the vapor concentration control system of this invention, no mixed gas is produced while the carrier gas flows in the first flow channel, and overshoot and cost increase can be prevented without consuming more gas or material than is necessary.

For the vapor concentration control system of this invention, it is preferable that the control part fixes the opening degree of the fluid adjusting valve at the initial opening degree when the carrier gas flows in the first flow channel.

In accordance with this arrangement, since the opening degree of the fluid adjusting valve is also fixed at the initial opening degree while the carrier gas flows in the first flow channel, at a time when the control part initiates the feedback control of the fluid adjusting valve, overshoot can be prevented securely unless the set concentration of the feedback control part at a previous time is largely different from the set concentration of the feedback control part at this time.

In addition, since the opening degree of the fluid adjusting valve is also fixed at the initial opening degree while the carrier gas flows in the first flow channel, there is no need to set the opening degree of the fluid adjusting valve to the initial opening degree at a time when the feedback control part switches the gas flowing in the first flow channel from the carrier gas to the mixed gas. As a result of this, it is possible to make the measurement concentration of the concentration sensor approach the set concentration more quickly.

It is preferable that the vapor concentration control system further comprises a second flow channel, wherein the carrier gas flows in from one end of the second flow channel located on the upstream side and the first flow channel is connected to one end of the second flow channel located on the downstream side, the second flow channel having a first diverging channel connected to an introducing pipe that introduces the carrier gas into the storage tank, and a second diverging channel connected to a lead out pipe that leads out the mixed gas from the storage tank.

With this arrangement, since the line where the carrier gas flows and the line where the mixed gas flows have the first flow channel and the second flow channel in common, it is possible to reduce a number of components of the vapor concentration control system by far compared with a case wherein the line where the carrier gas flows and the line where the mixed gas flows are separately provided.

It is preferable that the vapor concentration control system of this invention further comprises a flowmeter that measures a flow rate of at least either one of the carrier gas that is introduced from the introducing pipe to the storage tank and the mixed gas that is led out from the lead out pipe to the first flow channel.

If the opening degree of the fluid adjusting valve fluctuates rapidly, the pressure in the first flow channel rapidly rises or drops. Then, the flow rate control of the flowmeter cannot initiate in time, resulting in a problem that it is not possible to keep the flow rate during this period at a desired value. However, in accordance with the vapor concentration control system of this invention, since the control part initiates the control after setting the opening degree of the fluid adjusting valve at the initial opening degree when the mixed gas flows in the first flow channel, it is possible to prevent rapid fluctuation of the opening degree of the fluid adjusting valve, resulting in preventing the above-mentioned problem.

In addition, since the line where the carrier gas flows and the line where the mixed gas flows have the first flow channel and the second flow channel in common, a single flowmeter will suffice by being arranged at least for either one of the first flow channel and the second flow channel. As a result of this, it is possible to reduce a number of components of the flowmeter compared with a case of providing the line where the carrier gas flows and the line where the mixed gas flows separately.

### Effect of the Invention

In accordance with this invention, it is possible for the vapor concentration control system that produces either one of the carrier gas and the mixed gas selectively to prevent the measurement concentration of the material gas contained in the mixed gas from rising more than or equal to the previously set concentration and to prevent generation of overshoot.

### BRIEF DESCRIPTION OF THE DRAWINGS

FIG. 1 is a schematic view showing a vapor concentration control system in a first embodiment.

FIG. 2 is a block diagram showing a control part of the first embodiment.

FIG. 3 is a schematic view showing a vapor concentration control system in a second embodiment.

### BEST MODES OF EMBODYING THE INVENTION

A vapor concentration control system (hereinafter also referred to as “material gas concentration control system”) of a first embodiment of this invention will be explained with reference to the drawings.

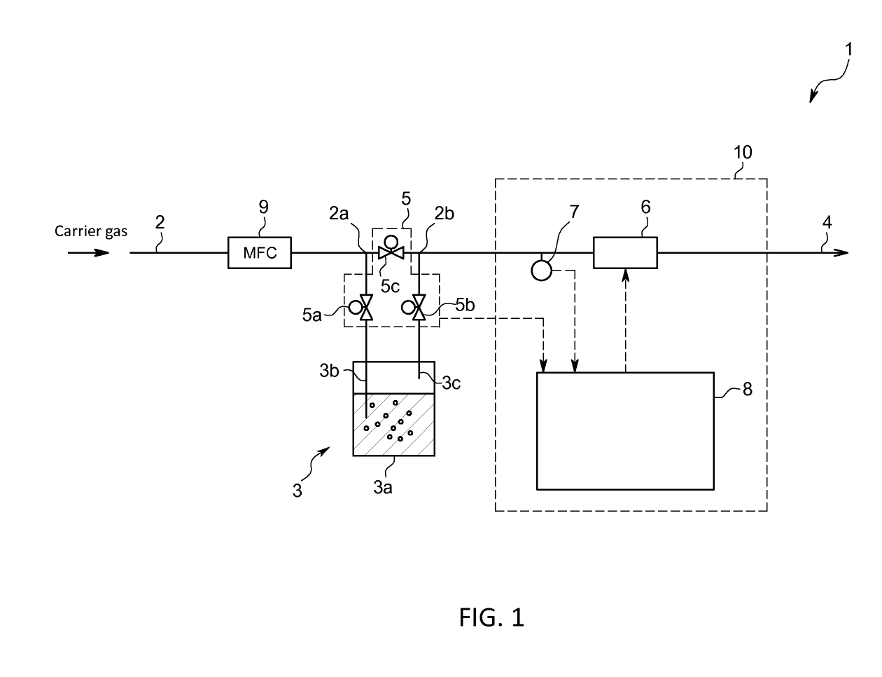

The material gas concentration control system 1 in accordance with the first embodiment comprises, as shown in FIG. 1, a second flow channel 2, a storage tank 3, a first flow channel 4, a switch valve 5 and a vapor concentration control device (also referred to as “material gas concentration control device”) 10.

The second flow channel 2 is so configured that a carrier gas flows in from one end located in the upstream side and one end located in the downstream side is connected to the first flow channel 4, and has a first diverging channel 2a and a second diverging channel 2b arranged on the downstream side of the first diverging channel 2a.

In addition, a mass flow controller 9 for controlling a flow rate of the carrier gas is provided in the upstream side of the first diverging channel 2a of the second flow channel 2.

The mass flow controller 9 has a fluid resistance element (not shown in drawings) and is of a differential pressure type that measures the flow rate of the carrier gas by measuring pressures in the upstream side and the downstream side of the fluid resistance element.

The storage tank 3 comprises a tank 3a where a liquid or solid material is stored, an introducing pipe 3b to introduce the carrier gas into the tank 3a, and a lead out pipe 3c to lead out a mixed gas made of a material gas, which is the liquid or solid material vaporized by means of the carrier gas, and the carrier gas from the tank 3a. The introducing pipe 3b is connected to the first diverging channel 2a of the second flow channel 2 and the lead out pipe 3c is connected to the second diverging channel 2b of the second flow channel 2.

The first flow channel 4 is so configured that one end located on the upstream side is connected to the second flow channel 2 and either one of the carrier gas and the mixed gas is led out from one end located on the downstream side.

The switch valve 5 is for flowing either one of the mixed gas and the carrier gas selectively to the first flow channel 4, and comprises a first valve 5a, a second valve 5b and a third valve 5c.

The first valve 5a is arranged on the introducing pipe 3b that is connected to the first diverging channel 2a of the second flow channel 2, and an inflow of the carrier gas flowing in the second flow channel 2 to the storage tank 3 is controlled by opening/closing the first valve 5a.

The second valve 5b is arranged on the lead out pipe 3c that is connected to the second diverging channel 2b of the second flow channel 2, and an inflow of the mixed gas produced in the storage tank 3 to the second flow channel 2 is controlled by opening/closing the second valve 5b.

The third valve 5c is arranged between the first diverging channel 2a and the second diverging channel 2b of the second flow channel 2, and the inflow of the carrier gas to the first flow channel 4 is controlled by opening/closing the third valve 5c.

The switch valve 5 flows the mixed gas to the first flow channel 4 by opening the first valve 5a and the second valve 5b and by closing the third valve 5c, and flows the carrier gas to the first flow channel 4 by opening the third valve 5c and by closing the first valve 5a and the second valve 5b.

The material gas concentration control device 10 is for controlling a concentration of a gas flowing in the first flow channel 4 and comprises a fluid adjusting valve 6, a concentration sensor 7, and a control part 8.

The concentration sensor 7 is arranged on the first flow channel 4 and measures the concentration of the material gas in the mixed gas flowing in the first flow channel 4.

The concentration sensor 7 of this embodiment makes use of that the concentration (vol %) of the material gas is expressed by a pressure (a partial pressure) of the material gas contained in the mixed gas/a pressure (a total pressure) of the mixed gas×100.

In other words, the concentration sensor 7 obtains the concentration of the material gas based on the pressure (the total pressure) of the mixed gas measured by the pressure meter (not shown in drawings) that measures the pressure (the total pressure) of the mixed gas in the storage tank 3 and the pressure (the partial pressure) of the material gas measured by a potentiometer (not shown in drawings) using, for example, a non-distributed infrared ray absorption method that measures the pressure (the partial pressure) of the material gas contained in the mixed gas flowing in the first flow channel 4.

The potentiometer using the non-distributed infrared ray absorption method comprises a light source part (not shown in drawings) and a light receiving part (not shown in drawings) arranged to face each other in the radial direction of the first flow channel 4, and measures the partial pressure of the material gas passing between the light source part and the light receiving part by making use of a phenomenon that a material gas molecule absorbs the infrared rays.

The concentration sensor 7 may use a concentration sensor that directly measures the concentration of the material gas by the use of, for example, supersonic waves.

The fluid adjusting valve 6 adjusts the concentration of the material gas by changing the pressure (the total pressure) of the gas flowing in the first flow channel 4 and is provided on the first flow channel 4 locating in the downstream side of the concentration sensor 7.

The fluid adjusting valve 6 comprises an adjusting valve body (not shown in drawings) arranged to block a channel in the first flow channel 4 and a driving part (not shown in drawings) that opens/closes the channel of the first flow channel 4 by driving the adjusting valve body that is mounted externally on the first flow channel 4 based on a control signal, to be described later.

Since the concentration of the material gas is expressed by the expression that the pressure (the partial pressure) of the material gas contained in the mixed gas/the pressure (the total pressure) of the mixed gas×100, in the case of decreasing the concentration of the material gas, the opening degree of the fluid adjusting valve 6 is adjusted to decrease in order to increase the pressure (the total pressure) of the mixed gas, and in case of increasing the concentration of the material gas, the opening degree of the fluid adjusting valve 6 is adjusted to increase in order to decrease the pressure (the total pressure) of the mixed gas.

The control part 8 is a so-called computer circuit having a CPU, an internal memory, an I/O buffer circuit, and an AD convertor. The control part 8 conducts an information process by operating in accordance with programs stored in a predetermined area of the internal memory and produces functions as a feedback control part 11, a fixing part 12, a switching part 13, a switch controlling part 14, and a receiving part 20, to be described later.

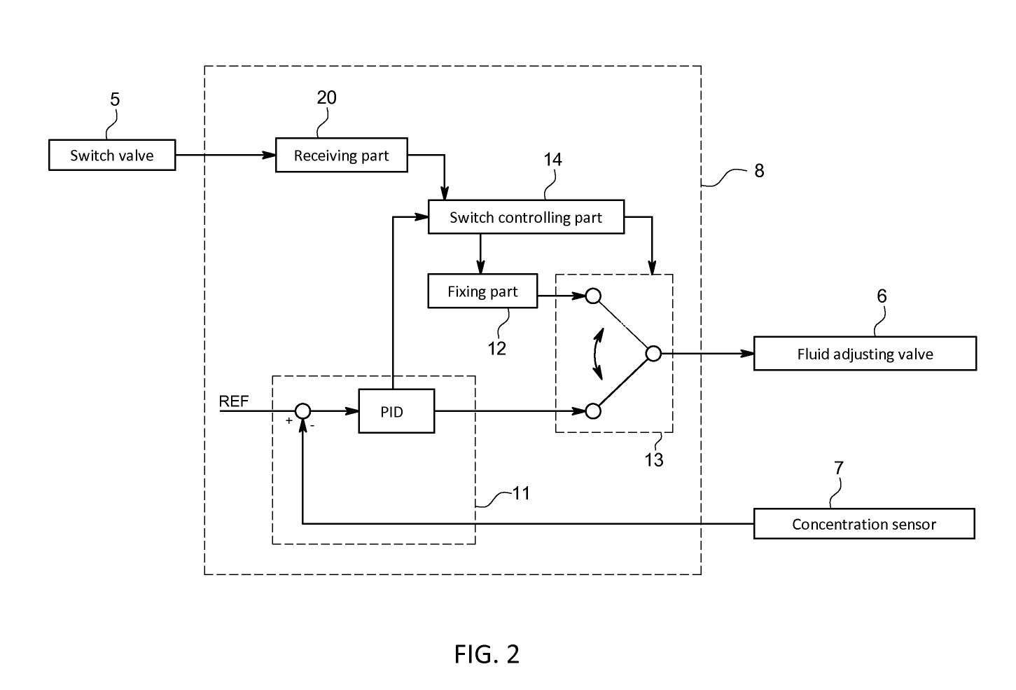

The feedback control part 11, the fixing part 12, the switching part 13, the switch controlling part 14, and the receiving part 20 will be explained by the use of a block diagram of the control part 8 shown in FIG. 2.

The feedback control part 11 produces a control signal so as to make a measurement concentration measured by the concentration sensor 7 and its related value approach a previously determined set concentration or its related value and inputs the control signal to the driving part of the fluid adjusting valve 6.

Concretely, if the previously described expression is deformed, the pressure (the total pressure) of the mixed gas is expressed by the pressure (the partial pressure) of the material gas contained in the mixed gas/the concentration of the material gas×100.

Then, when a target value of the material gas concentration is set, the feedback control part 11 produces a control signal by applying the pressure (the partial pressure) of the material gas measured by the potentiometer to the above-mentioned expression, calculating the pressure (the total pressure) of the mixed gas to be a target, and providing an arithmetic process such as a proportion operation, a differential operation, or an integral operation on a deviation between the target total pressure (the set concentration related value) and the measured total pressure (the measurement concentration related value) of the pressure meter, and then inputs the control signal to the driving part of the fluid adjusting valve 6.

In the case that the concentration sensor 7 measures the material gas concentration, the feedback control part 11 may produce a control signal by providing an arithmetic process such as a proportion operation, a differential operation, or an integral operation on a deviation between the measurement concentration of the material gas measured by the concentration sensor 7 and the set concentration to be a target and may input the control signal to the driving part of the fluid adjusting valve 6.

The fixing part 12 stores the control signal transmitted from the switch controlling part 14, to be described later, and inputs the control signal to the driving part of the fluid adjusting valve 6.

The switching part 13 switches the control of the fluid adjusting valve 6 from either one of the feedback control part 11 and the fixing part 12 to the other of them by the switch controlling part 14, to be described later.

The receiving part 20 receives a state signal indicating a state of the switch valve 5 (5a, 5b, 5c), and when the state of the switch valve 5 (5a, 5b, 5c) is switched with the third valve 5c open and the first valve 5a and the second valve 5b closed, the receiving part 20 transmits the switch signal to the switch controlling part 14, to be described later.

When the switch controlling part 14 receives the switch signal from the receiving part 20, the switch controlling part 14 transmits the control signal produced at a time just before receiving the switch signal by the feedback control part 11 to the fixing part 12.

In addition, when the measurement concentration measured by the concentration sensor 7 becomes less than a predetermined concentration, the switch controlling part 14 switches the control of the fluid adjusting valve 6 from the feedback control part 11 to the fixing part 12. When the measurement concentration measured by the concentration sensor 7 exceeds the predetermined concentration, the switch controlling part 14 switches the control of the fluid adjusting valve 6 from the fixing part 12 to the feedback control part 11.

An operation and control of the material gas concentration control system of this invention will be explained.

In a state that the third valve 5c of the switch valve 5 is closed and the first valve 5a and the second valve 5b are open, when the carrier gas flows from the upstream of the second flow channel 2, the carrier gas is introduced into the storage tank 3 from the first diverging channel 2a through the introducing pipe 3b. The carrier gas introduced into the storage tank 3 vaporizes the material stored in the storage tank 3 and the mixed gas made of the material gas, which is the vaporized material, and the carrier gas is produced. The mixed gas stored in the storage tank 3 passes through the lead out pipe 3c, flows in the second flow channel 2 through the second diverging channel 2b and then flows in the first flow channel 4 that is connected to the second flow channel 2.

At this time, the feedback control part 11 calculates the target total pressure (the set concentration related value) based on the pressure (the partial pressure) of the material gas contained in the mixed gas flowing in the first flow channel 4 measured by the potentiometer and the previously determined set concentration, and produces the control signal by providing the arithmetic process on the deviation between the target total pressure (the set concentration related value) and the measurement total pressure (the measurement concentration related value) of the pressure meter, and then inputs the control signal to the driving part of the fluid adjusting valve 6. Then the fluid adjusting valve 6 drives the adjusting valve body by receiving the control signal input to the driving part of the fluid adjusting valve 6 and changes the opening degree of the fluid adjusting valve 6.

As mentioned above, in the case of decreasing the material gas concentration, the feedback control part 11 inputs the control signal so as to decrease the opening degree of the fluid adjusting valve 6 in order to increase the pressure (the total pressure) of the mixed gas. Accordingly, in the case of increasing the material gas concentration, the feedback control part 11 inputs the control signal so as to increase the opening degree of the fluid adjusting valve 6 in order to decrease the pressure (the total pressure) of the mixed gas.

As mentioned above, the feedback control part 11 makes the measurement total pressure (the measurement concentration related value) approach the target total pressure (the set concentration related value) by adjusting the opening degree of the fluid adjusting valve 6.

Next, in a state that the first valve 5a and the second valve 5b of the switch valve 5 are closed and the third valve 5c is open, when the carrier gas flows from the upstream side of the second flow channel 2, the gas flowing in the first flow channel 4 is switched from the mixed gas to the carrier gas.

At this time, the receiving part 20 senses that the state of the switch valve 5 is switched and transmits a switch signal to the switch controlling part 14.

The switch controlling part 14 receives the switch signal from the receiving part 20 and transmits a control signal produced by the feedback control part 11 at a time just before receiving the switch signal to the fixing part 12.

Since the carrier gas flowing in the first flow channel 4 does not contain the material gas, the measurement concentration measured by the concentration sensor 7 drops. When the measurement concentration becomes less than the predetermined concentration, the switch controlling part 14 switches the control of the fluid adjusting valve 6 from the feedback control part 11 to the fixing part 12. The fixing part 12 inputs the transmitted control signal to the driving part of the fluid adjusting valve 6 and drives the adjusting valve body of the fluid adjusting valve 6.

As a result of this, while the fixing part 12 controls the fluid adjusting valve 6, the opening degree of the fluid adjusting valve 6 is fixed at an opening degree controlled by the control signal produced by the feedback control part 11 at a time just before the switch controlling part 14 receives the switch signal, in other words, the opening degree at a time just before the gas flowing in the first flow channel 4 is switched from the mixed gas to the carrier gas.

In a state that the third valve 5c of the switch valve 5 is closed again and the first valve 5a and the second valve 5b are open again, when the carrier gas flows from the upstream side of the second flow channel 2, the fluid flowing in the first flow channel 4 is switched from the carrier gas to the mixed gas. As a result of this, the measurement concentration measured by the concentration sensor 7 rises. When the measurement concentration exceeds the predetermined concentration, the switch controlling part 14 switches the control of the fluid adjusting valve 6 from the fixing part 12 to the feedback control part 11.

At this time, until just before the switch controlling part 14 switches the control of the fluid adjusting valve 6 from the fixing part 12 to the feedback control part 11, the opening degree of the fluid adjusting valve 6 is fixed at the opening degree at a time just before the gas flowing in the first flow channel 4 is switched from the mixed gas to the carrier gas.

As a result of this, when the gas flowing in the first flow channel 4 is switched to the mixed gas again, the feedback control part 11 initiates the feedback control of the fluid adjusting valve 6 by the use of the opening degree of the fluid adjusting valve 6 at a time just before the gas flowing in the first flow channel 4 is switched from the mixed gas to the carrier gas as an initial opening degree.

In the above-mentioned embodiment, in the case that the measurement concentration exceeds the predetermined concentration or is less than the predetermined concentration, the control of the fluid adjusting valve 6 is switched to either one of the feedback control part 11 and the fixing part 12 to the other of them, however, it may be so configured that the control of the fluid adjusting valve 6 is switched from either one of the feedback control part 11 and the fixing part 12 to the other of them when the predetermined conditions that are described below are satisfied.

The predetermined conditions may include a case that the measurement concentration exceeds the predetermined concentration or becomes less than the predetermined concentration and a predetermined period of time passes, a case that the measurement concentration exceeds the predetermined concentration and reaches the predetermined concentration+a, and a case that when the switch controlling part 14 receives a switch signal that the state of the switch valve 5 is switched or when a predetermined period of time passes after the switch controlling part 14 receives a switch signal that the state of the switch valve 5 is switched.

In accordance with the material gas concentration control system 1 of this embodiment, since the feedback control part 11 initiates the feedback control by the use of the opening degree of the fluid adjusting valve 6 at the time just before the gas flowing in the first flow channel 4 is switched from the mixed gas to the carrier gas as the initial opening degree, it is possible to prevent overshoot by suppressing a rapid rise of the measurement concentration due to the opening degree of the fluid adjusting valve 6.

In addition, since the material gas concentration control system 1 of this embodiment does not produce the mixed gas while the carrier gas flows in the first flow channel 4, it is possible to prevent overshoot without unnecessarily consuming the gas and the material so that the cost is prevented from being increased.

In accordance with the material gas concentration control system 1 of this embodiment, since the fixing part 12 fixes the opening degree of the fluid adjusting valve 6 at the opening degree at the time just before the gas flowing in the first flow channel 4 is switched from the mixing gas to the carrier gas, it is possible to prevent a rapid rise of the measurement concentration securely at a time when the control part 8 initiates the feedback control of the fluid adjusting valve 6.

In accordance with the material gas concentration control system 1 of this embodiment, if a line where the carrier gas flows and a line where the mixed gas flows have the first flow channel 4 and the second flow channel 2 in common, it is possible to largely decrease a number of components of the material gas concentration control system 1 compared with a case that the line where the carrier gas flows and the line where the mixed gas flows are provided separately.

In addition, if the opening degree of the fluid adjusting valve 6 rapidly fluctuates, the pressure in the first flow channel 4 rapidly rises or drops. As a result of this, the control of the flow rate of the mass flow controller 9 cannot initiate in time, resulting in a problem of being unable to keep the flow rate of the mass flow controller 9 at a desired value.

However, in accordance with the material gas concentration control system 1 of this embodiment, since the feedback control part 11 initiates the control after the opening degree of the fluid adjusting valve 6 is set at the initial opening degree, it is possible to prevent rapid fluctuation of the opening degree of the fluid adjusting valve 6 so that the above-mentioned problem can be prevented.

In addition, with the arrangement wherein the line where the carrier gas flows and the line where the mixed gas flows have the first flow channel 4 and the second flow channel 2 in common, since it will suffice if a single flowmeter is arranged at least at either one of the first flow channel 4 and the second flow channel 2, it is possible to decrease a number of components of the flowmeter compared with a case that the line where the carrier gas flows and the line where the mixed gas flows are provided separately.

Since the material gas concentration control system 1 of this embodiment is so configured that the feedback control part 11 conducts the control by the use of the measurement concentration related value and the set concentration related value, it is possible for the feedback control part 11 to conduct the control with higher accuracy compared with a case of using the material gas measurement concentration and the set concentration that are indirectly measured by the concentration sensor based on the total pressure of the mixed gas and the partial pressure of the material gas.

Next, a material gas concentration control system 1′ in accordance with a second embodiment of this invention will be explained with reference to drawings.

The same parts of the material gas concentration control system 1′ in the second embodiment are denoted by the same reference numerals as those of the material gas concentration control system 1 in the first embodiment, and descriptions thereof will be omitted.

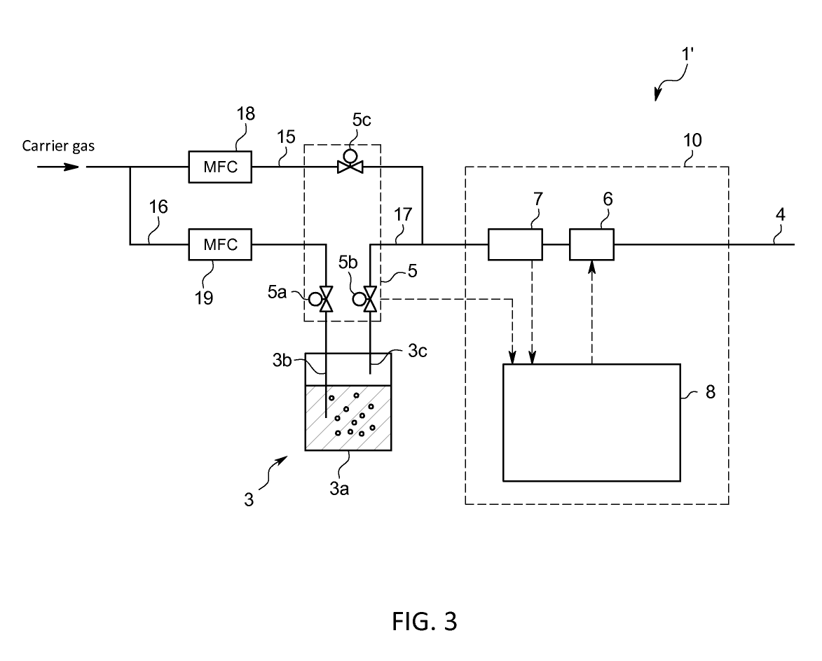

The material gas concentration control system 1′ in accordance with the second embodiment comprises, as shown in FIG. 3, a third flow channel 15 from one end of which on the upstream side the carrier gas flows and whose one end on the downstream side is connected to the first flow channel 4, a forth flow channel 16 from one end of which on the upstream side the carrier gas flows and whose one end on the downstream side is connected to the introducing pipe 3b that introduces the carrier gas to the storage tank 3, and a fifth flow channel 17 whose one end on the upstream side is connected to the lead out pipe 3c that leads out the mixed gas from the storage tank 3 and whose one end on the downstream side is connected to the first flow channel 4.

The third flow channel 15 comprises the third valve 5c that controls the inflow of the carrier gas to the first flow channel 4 and a mass flow controller 18 for controlling the flow rate of the carrier gas flowing in the first flow channel 4.

The forth flow channel 16 comprises the first valve 5a that controls the inflow of the carrier gas to the storage tank 3 and a mass flow controller 19 for controlling the flow rate of the carrier gas flowing in the storage tank 3.

The firth flow channel 17 comprises the second valve 5b that controls the inflow of the mixed gas to the first flow channel 4.

The material gas concentration control system 1′ in the second embodiment is so configured that a receiving part 20 transmits a switch signal to the switch controlling part 14 when the third valve 5c is open and the first valve 5a and the second valve 5b are closed so that a state of the valve 5 is switched.

When the switch controlling part 14 receives the switch signal, the control signal produced by the feedback control part 11 at the time just before the switch controlling part 14 receives the switch signal is transmitted to the fixing part 12. Later, when the switching part 13 switches the control of the fluid adjusting valve 6 from the feedback control part 11 to the fixing part 12, the fixing part 12 stores the control signal and inputs the control signal to the driving part of the fluid adjusting valve 6.

Then, when the third valve 5c is closed and the first valve 5a and the second valve 5b are open, the gas flowing in the first flow channel 4 is switched from the carrier gas to the mixed gas.

When the measurement concentration of the material gas contained in the mixed gas flowing in the first flow channel 4 exceeds the predetermined concentration, the switch controlling part 14 switches the control of the fluid adjusting valve 6 from the fixing part 12 to the feedback control part 11.

At this time, the opening degree of the fluid adjusting valve 6 is fixed at the opening degree at the time just before the gas flowing in the first flow channel 4 is switched from the mixed gas to the carrier gas by the fixing part 12 until just before the switch controlling part 14 switches the control of the fluid adjusting valve 6 from the fixing part 12 to the feedback control part 11.

With this arrangement of the material gas concentration control system 1′ of the second embodiment wherein the line where the carrier gas flows and the line where the mixed gas flows are separately provided, since the feedback control part 11 initiates the feedback control by the use of the opening degree of the fluid adjusting valve 6 at the time just before the gas flowing in the first flow channel 4 is switched from the mixed gas to the carrier gas as the initial opening degree, it is possible to prevent overshoot by suppressing a rapid rise of the measurement concentration due to the opening degree of the fluid adjusting valve 6.

The present claimed invention is not limited to the above-mentioned embodiments.

The material gas concentration control system of the first embodiment uses the predetermined concentration as the threshold that the switch controlling part switches the control of the fluid adjusting valve from either one of the feedback control part and the fixing part to the other of them, however, the threshold may be, for example, a time when an open/close state of the first valve and the second valve, and the third valve are switched, or may be a time when the predetermined period of time passes after the switch valve is switched.

In addition, if a bridge circuit is formed by winding two pairs of heating resistance lines around the first flow channel or the second flow channel and the fluid flows in the first flow channel or the second flow channel in a state that an electrical current flows in the heating resistance lines and the heating resistance lines are heated, a temperature difference generates between the two pairs of the heating resistance lines. The mass flow controller may be of a thermal type that measures the flow rate of the fluid by the use of this temperature difference.

In addition, the mass flow controller may be provided at an appropriately desired position to be tailored to a design of the material gas concentration control system.

For the material gas concentration control system of this invention, the first flow channel, the second flow channel, the third flow channel, the forth flow channel, and the fifth flow channel may be provided with mirror finished. In accordance with this arrangement, it is possible to prevent the material from constricting the flow channel because the material gas is liquefied or solidified in the first flow channel, the second flow channel, the third flow channel, the forth flow channel, or the fifth flow channel. In addition, it can be conceived that a material of the first flow channel, the second flow channel, the third flow channel, the forth flow channel, and the fifth flow channel is stainless or the like, however, in case of using a gas having corrosive properties, it is preferable to be a corrosion resistant resin such as Teflon (trademark).

The present claimed invention may be variously modified without departing from a spirit of the invention.

### EXPLANATION OF REFERENCE CHARACTERS

1 . . . vapor concentration control system (material gas concentration control system)
3 . . . storage tank
4 . . . first flow channel
5 . . . switch valve
6 . . . fluid adjusting valve
7 . . . concentration sensor
8 . . . control part
10 . . . vapor concentration control device (material gas concentration control device)

1. A vapor concentration control system comprising
a storage tank that stores a liquid or solid material, where a carrier gas is introduced and a mixed gas is led out, the mixed gas being made of the carrier gas and material gas which is vaporized material from the liquid or solid material,
a first flow channel that is arranged on a downstream side of the storage tank,
a switch valve that is configured to flow the mixed gas or the carrier gas to the first flow channel selectively,
a fluid adjusting valve that adjusts a concentration of a gas flowing in the first flow channel,
a concentration sensor that measures a concentration of the material gas in the gas flowing in the first flow channel, and
a control part that conducts a feedback control on an opening degree of the fluid adjusting valve so as to make a measurement concentration measured by the concentration sensor or its related value approach a previously determined set concentration or its related value when the mixed gas flows in the first flow channel, wherein
the control part initiates the feedback control by the use of the opening degree of the fluid adjusting valve at a time just before the gas flowing in the first flow channel is switched from the mixed gas to the carrier gas as an initial opening degree of the fluid adjusting valve at a time when the gas flowing in the first flow channel is again switched to the mixed gas afterward.

2. The vapor concentration control system described in claim 1, wherein
when the carrier gas flows in the first flow channel, the control part fixes the opening degree of the fluid adjusting valve at the initial opening degree.

3. The vapor concentration control system described in claim 1, further comprising a second flow channel, wherein the carrier gas flows in from one end of the second flow channel located on the upstream side and the first flow channel is connected to one end of the second flow channel located on the downstream side, the second flow channel having a first diverging channel connected to an introducing pipe that introduces the carrier gas into the storage tank, and a second diverging channel connected to a lead out pipe that leads out the mixed gas from the storage tank.

4. The vapor concentration control system described in claim 3, further comprising
a flowmeter that measures a flow rate of at least either one of the carrier gas that is introduced from the introducing pipe to the storage tank and the mixed gas that is led out from the lead out pipe to the first flow channel.

5. A vapor concentration control device comprising
a fluid adjusting valve that is mounted on a flow channel where a carrier gas or a mixed gas made of a material gas, which is a vaporized material, and the carrier gas flows selectively and that adjusts a concentration of the material gas flowing in the flow channel,
a concentration sensor that is mounted on the flow channel and that measures the concentration of the material gas in a gas flowing in the flow channel, and
a control part that conducts a feedback control with an opening degree of the fluid adjusting valve at a time just before the gas flowing in the flow channel is switched from the mixed gas to the carrier gas as an initial opening degree of the fluid adjusting valve at a time when the gas flowing in the flow channel is again switched to the mixed gas afterward in order to make a measurement concentration measured by the concentration sensor or its related value approach a previously determined set concentration or its related value.

6. A control program of a vapor concentration control device comprising a fluid adjusting valve that is mounted on a flow channel where a carrier gas or a mixed gas made of a material gas, which is a vaporized material, and the carrier gas flows selectively and that adjusts a concentration of the material gas flowing in the flow channel, a concentration sensor that is mounted on the flow channel and that measures the concentration of the material gas in a gas flowing in the flow channel, and a control part that controls an opening degree of the fluid adjusting valve by the use of the measurement concentration measured by the concentration sensor or its related value, wherein
the control program makes the control part function as a feedback control part to make a measurement concentration measured by the concentration sensor or its related value approach a previously determined set concentration or its related value with an opening degree of the fluid adjusting valve at a time just before the gas flowing in the flow channel is switched from the mixed gas to the carrier gas as an initial opening degree of the fluid adjusting valve at a time when the gas flowing in the flow channel is again switched to the mixed gas afterward.
